(19) United States
(12) Patent Application Publication
(10) Pub. No.: US 2023/0186272 A1
(43) Pub. Date: Jun. 15, 2023

(54) INFORMATION PROCESSING APPARATUS AND SERVER APPARATUS FOR STORE SYSTEM WITH PERIPHERAL DEVICE BROKERING

(71) Applicant: TOSHIBA TEC KABUSHIKI KAISHA, Tokyo (JP)

(72) Inventor: Mikihiro KANOMATA, Izunokuni Shizuoka (JP)

(21) Appl. No.: 17/970,483

(22) Filed: Oct. 20, 2022

(30) Foreign Application Priority Data
Dec. 15, 2021 (JP) 2021-203707

(51) Int. Cl. G06Q 20/20; H04W 8/22; H04W 76/10; G06K 7/14

(52) U.S. Cl. CPC G06Q 20/208; H04W 8/22; H04W 76/10; G06K 7/1404; H04W 88/04

(57) ABSTRACT

According to an embodiment, an information processing apparatus includes a device connection unit to allow a plurality of devices to be detachably connected thereto, a processor, and a network communication interface to communicate with a server apparatus. The processor receives from, the device connection unit, an input of first identification information from a first device connected to the device connection unit. The first identification information identifies a particular mobile terminal connected to the network. The processor notifies the server apparatus, via the network communication interface, of an association between the first identification information and second identification information of the information processing apparatus to cause the server apparatus to relay information between the mobile terminal and the information processing apparatus. The processor also executes an accounting processing, using one or more devices connected to the device connection unit, for receiving payments for items registered by the mobile terminal.

### CROSS-REFERENCE TO RELATED APPLICATION

This application is based upon and claims the benefit of priority from Japanese Patent Application No. 2021-203707, filed Dec. 15, 2021, the entire contents of which are incorporated herein by reference.

### FIELD

Embodiments described herein relate generally to an information processing apparatus and a server apparatus for retail store systems with peripheral device brokering, sharing, or the like.

### BACKGROUND

In stores such as supermarkets, a system that enables purchasing of items using a mobile terminal, such as a smartphone or a tablet terminal, has been introduced. In such a system, in order to use various peripheral devices, such as a receipt printer, provided at the store, as part of a transaction, the mobile terminal can be connected to the peripheral device by wireless communication.

However, in this system described above, whenever the peripheral device is to be used, the mobile terminal and the device need to communicate with each other, which requires separately establishing a connection for each different device use, and this complicates the operations of the system. In addition, there is always a possibility that the connection between the mobile terminal and the peripheral device cannot be established at the required time, and thus there is room for improvement in terms of convenience for such a system.

### BRIEF DESCRIPTION OF THE DRAWINGS

FIG. 1 is a diagram of a checkout system according to an embodiment.

FIG. 2 is a diagram of a hardware configuration of a mobile terminal.

FIG. 3 is a diagram of a hardware configuration of a device broker.

FIG. 4 is a diagram illustrating an example of a data configuration of a device management table.

FIG. 5 is a diagram of a hardware configuration of a server apparatus.

FIG. 6 is a diagram illustrating an example of a data configuration of a commodity master.

FIG. 7 is a diagram illustrating an example of a data configuration of a device broker management table.

FIG. 8 is a diagram illustrating an example of a data configuration of a shopping information management table.

FIG. 9 is a diagram illustrating an example of a data configuration of an association management table.

FIG. 10 is a diagram illustrating certain functional aspects of a mobile terminal, a device broker, and a server apparatus.

FIG. 11 is a diagram illustrating an example of an association support screen.

FIG. 12 is a flowchart of device state management executed by a device broker and a server apparatus.

FIG. 13 is a flowchart of commodity registration executed by a mobile terminal and a server apparatus.

FIG. 14 is a flowchart illustrating an example of an association executed by a device broker and a server apparatus.

FIG. 15 is a flowchart illustrating an example of associated accounting executed by a mobile terminal, a device broker, and a server apparatus.

FIG. 16 is a diagram illustrating an example of a data configuration of a device management table according to a modification.

FIG. 17 is a diagram illustrating an example of a data configuration of a device broker management table according to a modification.

### DETAILED DESCRIPTION

In general, according to one embodiment, an information processing apparatus and a server apparatus that enable use of a peripheral-type device by a mobile terminal without requiring directly connecting the mobile terminal to the device are provided.

According to one embodiment, an information processing apparatus includes a device connection unit configured to allow a plurality of devices to be detachably connected thereto, a network communication interface configured to communicate with a server apparatus, and a processor. The processor is configured to receive from the device connection unit an input of first identification information from a first device connected to the device connection unit, the first identification information identifying a particular mobile terminal connected to the network; notify the server apparatus, via the network communication interface, of an association between the first identification information and second identification information of the information processing apparatus to cause the server apparatus to relay information between the particular mobile terminal and the information processing apparatus; and execute accounting processing for a commodity registered by the particular mobile terminal, the accounting processing using one or more devices connected to the device connection unit.

Hereinafter, certain example embodiments of an information processing apparatus and a server apparatus will be described with reference to the drawings. The example embodiments concern a checkout system at a retail store such as a supermarket, but disclosed embodiments are not limited to such an application nor to the specific details of the example embodiments.

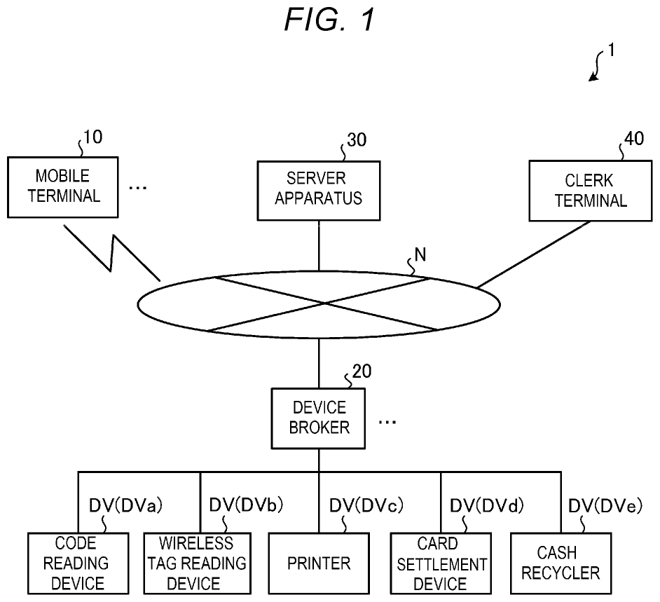

FIG. 1 is a diagram illustrating an example of a configuration of a checkout system 1. The checkout system 1 includes a mobile terminal 10, a device broker 20, a server apparatus 30, and a clerk terminal 40.

The mobile terminal 10 is connected to a network N by wireless communication via an access point or the like. In addition, the device broker 20, the server apparatus 30, and the clerk terminal 40 are connected to the network N in a wired or wireless manner. Here, the network N is, for example, a local area network (LAN) provided in the store.

The number of mobile terminals 10, device brokers 20, clerk terminals 40, and server apparatuses 30 connected to the network N are not limited to the example illustrated in FIG. 1. In some examples, the clerk terminal 40 may be wirelessly connected to the network N.

The mobile terminal 10 is a mobile device such as a smartphone or a tablet terminal. For example, the mobile terminal 10 may be a terminal device such as a smartphone owned by a customer or a clerk, or may be a terminal device lent to the customer by the store. In the latter case, the mobile terminal 10 may be, for example, a tablet terminal attached to a shopping cart (a so-called “cart terminal” or “cart POS”). For the present embodiment, the customer operates the mobile terminal 10, but in other embodiments a store clerk may operate the mobile terminal 10. Hereinafter, a customer who operates the mobile terminal 10 is also referred to as an “operator”.

The mobile terminal 10 executes a process for purchasing a commodity (hereinafter, also referred to as commodity sales data processing) in response to an operation by the operator. Specifically, the mobile terminal 10 executes a registration for registering a commodity to be purchased in response to the operation of the operator. That is, the mobile terminal 10 of the present embodiment functions as a registration machine that executes the registration of the commodity.

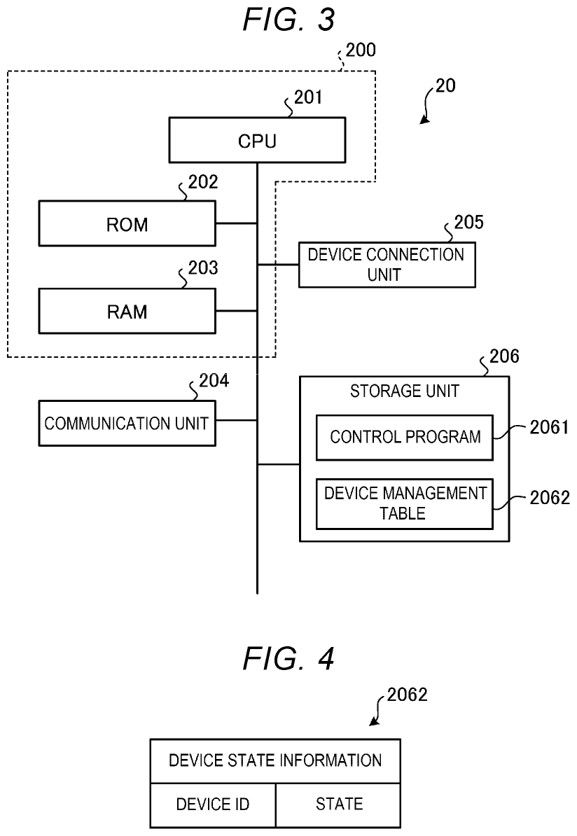

The device broker 20 is an example of an information processing apparatus. The device broker 20 allows various devices DV that may serve as peripheral equipment of the mobile terminal 10 to be connected to, or otherwise accessed by, the mobile terminal 10. The device broker 20 is placed, for example, at a predetermined position in the store. Specifically, the device broker 20 includes a device connection unit 205 (refer to FIG. 3) that allows one or a plurality of devices DV to be detachably connected thereto.

For example, a code reading device DVa capable of reading a code symbol such as a bar code or a two-dimensional code is connected to the device broker 20 as one type of a device DV. A wireless tag reading device DVb capable of reading (or writing) a wireless tag such as a radio frequency identifier (RFID) tag is connected to the device broker 20 as one type of a device DV. A printer DVc such as a receipt printer is connected to the device broker 20 as one type of a device DV. A card settlement device DVd that allows payment by a credit card is connected to the device broker 20 as one type of a device DV. A cash recycler DVe having a function of receiving money (banknotes or coins), sorting the money by denomination and storing the money, and a function of dispensing change from stored money is connected to the device broker 20 as one type of a device DV. A cash recycler DVe may also be referred to as a cash handler device, a cash handling device, a money handling device, currency handler, or the like.

The types and the numbers of the devices DV connected to the device broker 20 are not particularly limited, but at least a device DV that can be used for inputting association information (for example, a code reading device DVa), is connected to the device broker 20.

In addition, in the present embodiment, a device DV that permits payment for the registered commodity is connected to the device broker 20. The device broker 20 may also execute an accounting process (also referred to as a settlement) for registered commodities in cooperation with the connected devices DV. That is, the device broker 20 and the device DV of the present embodiment collectively function as an accounting machine that executes the accounting on the registered commodity in the commodity sales data processing.

The server apparatus 30 is, for example, a store server provided in the store. The server apparatus 30 integrally manages the checkout system 1. For example, the server apparatus 30 stores and manages information related to the commodities sold in the store. In addition, the server apparatus 30 tracks/manages a state of each device broker 20 and a state of each device DV connected to the device broker 20. The server apparatus 30 also manages the association between the mobile terminal 10 and the device broker 20.

The clerk terminal 40 is a terminal device operated by a clerk (e.g., a store employee or the like) at the store. The clerk terminal 40 may be a stationary terminal device such as a personal computer (PC), or may be a mobile terminal device such as a smartphone.

In the checkout system 1 described above, the operator of the mobile terminal 10 registers a commodity for purchase using the mobile terminal 10, and then pays for the registered commodity using a device DV connected to the device broker 20. That is, the checkout system 1 realizes a checkout system of a type in which registration and accounting can be performed by the customer by himself/herself without interaction with the clerk (this is also referred to as a self-service type system or the like). In a system in which the clerk operates the mobile terminal 10, the checkout system 1 can be of a type in which operations related to registration are performed by the clerk but operations related to settlement are performed by the customer (this is also referred to as a semi-self-service type system or a pre-handling type system).

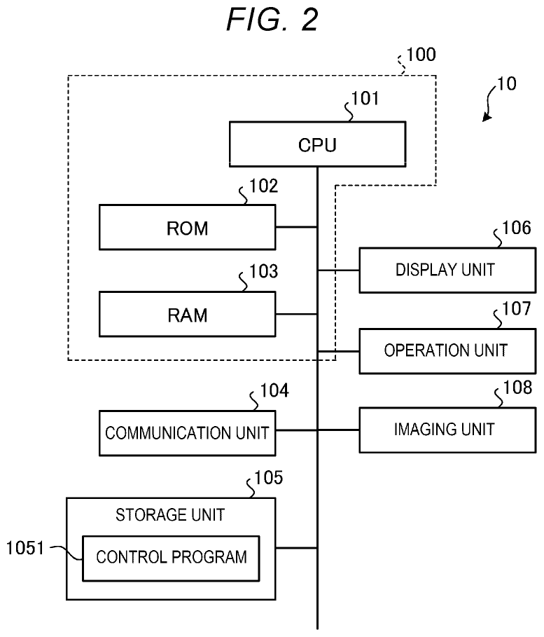

Next, a configuration of devices of the checkout system 1 will be described. First, a hardware configuration of the mobile terminal 10 will be described with reference to FIG. 2. FIG. 2 is a diagram illustrating an example of the hardware configuration of the mobile terminal 10.

As illustrated in FIG. 2, the mobile terminal 10 includes a central processing unit (CPU) 101, a read only memory (ROM) 102, and a random access memory (RAM) 103.

The CPU 101 is an example of a processor and controls an operation of the mobile terminal 10. The ROM 102 stores various programs. The RAM 103 is a workspace for loading the programs and various data. The CPU 101, the ROM 102, and the RAM 103 are connected via a bus or the like and constitute a control unit 100. The control unit 100 executes various processes by the CPU 101 operating in accordance with a control program 1051 stored in the ROM 102 or a storage unit 105 and loaded into the RAM 103.

The CPU 101 is connected to a communication unit 104 and the storage unit 105 via a bus or the like. The communication unit 104 is a wireless communication interface connectable to the network N. The communication unit 104 communicates with the server apparatus 30 via the network N.

The storage unit 105 is a storage device such as a hard disk drive (HDD), a solid-state drive (SSD), or a flash memory, and maintains stored content even when power is turned off. The storage unit 105 stores, for example, the control program 1051.

The control program 1051 is for controlling the operation of the mobile terminal 10. The control unit 100 (more specifically, the CPU 101) executes with the control program 1051 to realize various functions.

The control program 1051 may include a communication program or setting information for automatically connecting to the server apparatus 30. The storage unit 105 may store other data. For example, the storage unit 105 may store a commodity master 3052, and the like.

In addition, the CPU 101 is connected to a display unit 106, an operation unit 107, and an imaging unit 108 via a bus or the like.

The display unit 106 includes a display device such as a liquid crystal display. The display unit 106 displays various screens under the control of the CPU 101. For example, the display unit 106 displays an operation screen for supporting a registration operation of the commodity. The display unit 106 may include a touch panel.

The operation unit 107 includes various operation keys, pointing devices, user input devices, and the like to receive input operations of the operator of the mobile terminal 10. The operation unit 107 may be a touch panel provided on a display surface of the display unit 106.

The imaging unit 108 is an imaging device including an imaging element such as a charge coupled device (CCD) or a complementary MOS (CMOS) element. In the present embodiment, the imaging unit 108 is used to read a code symbol attached to the commodity.

Next, a hardware configuration of the device broker 20 will be described with reference to FIG. 3. FIG. 3 is a diagram illustrating an example of the hardware configuration of the device broker 20. In some examples, the device broker 20 may also be usable as, or at least correspond in outward appearance to, a self-service point-of-sale terminal, a semi-self-service point-of-sale terminal, a customer checkout kiosk, or the like.

As illustrated in FIG. 3, the device broker 20 includes a CPU 201, a ROM 202, and a RAM 203.

The CPU 201 is an example of a processor and controls an operation of the device broker 20. The ROM 202 stores various programs. The RAM 203 is a workspace for loading the programs and various data. The CPU 201, the ROM 202, and the RAM 203 are connected via a bus or the like to constitute a control unit 200. The control unit 200 executes various processes by the CPU 201 operating in accordance with a control program 2061 stored in the ROM 202 or a storage unit 206 and loaded into the RAM 203.

In addition, the CPU 201 is connected to a communication unit 204, the device connection unit 205, and the storage unit 206 via a bus or the like. The communication unit 204 is a communication interface connectable to the network N. The communication unit 204 communicates with the server apparatus 30 via the network N.

The device connection unit 205 is also referred to as a connection unit, a device interface board, a peripheral device interface unit, or the like. The device connection unit 205 includes a plurality of interfaces that allow the device DV to be detachably connected thereto. The device connection unit 205 may include various interface types such as universal serial bus (USB) and/or RS-232C.

The storage unit 206 is a storage device such as an HDD, an SSD, or a flash memory, and maintains stored content even when power is turned off. The storage unit 206 stores, for example, the control program 2061 and a device management table 2062.

The control program 2061 is for controlling the operations of the device broker 20. The control unit 200 (more specifically CPU 201) executes the control program 2061 to realize various functions.

The device management table 2062 is a data table for managing the state of the devices DV connected to the device broker 20. FIG. 4 is a diagram illustrating an example of a data configuration of the device management table 2062.

As illustrated in FIG. 4, the device management table 2062 stores device state information illustrating the state of a device DV connected to the device broker 20. The device state information includes, for example, a device ID and a state.

Here, the device ID is identification information for uniquely identifying each of the devices DV connected to the device broker 20. The state is information indicating the present state of the device DV corresponding to the device ID. The state column stores, for example, entries such as “operating”, “idle” (standby), or “unusable” (due to occurrence of an abnormality) or the like. In addition, the state column may store information indicating a cause of an unusable state (e.g., an error code). For example, a cause of the unusable state, a paper out notice or the like may be stored in the state column in a case of the printer DVc, or a change empty notice or the like may be stored in the state column in a case of the cash recycler DVe.

The data configuration of the device management table 2062 is not limited to FIG. 4. For example, the device management table 2062 may store the device state information in association with identification information for identifying each individual interface (interface ID) of the device connection unit 205 rather than (or in addition to) the device IDs of the connected devices DV per se. With such a data configuration, it is possible to easily confirm relationships between the interfaces of the device connection unit 205 and the devices DV.

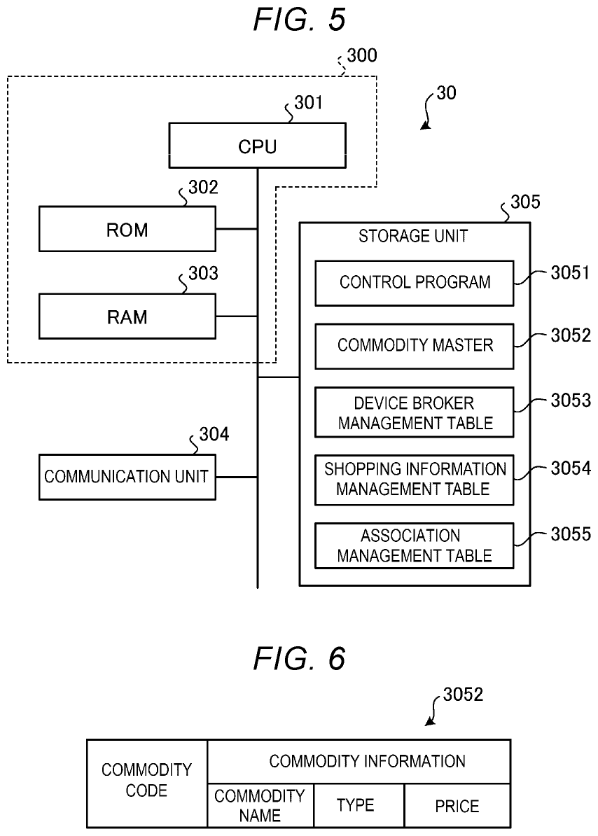

Next, a hardware configuration of the server apparatus 30 will be described with reference to FIG. 5. FIG. 5 is a diagram illustrating an example of the hardware configuration of the server apparatus 30.

As illustrated in FIG. 5, the server apparatus 30 includes a CPU 301, a ROM 302, and a RAM 303.

The CPU 301 is an example of a processor and controls operations of the server apparatus 30. The ROM 302 stores various programs. The RAM 303 is a workspace for loading the programs and various data. The CPU 301, the ROM 302, and the RAM 303 are connected via a bus or the like to constitute a control unit 300. The control unit 300 executes various processes by the CPU 301 operating in accordance with a control program 3051 stored in the ROM 302 or a storage unit 305 and loaded into the RAM 303.

The CPU 301 is connected to a communication unit 304 and the storage unit 305 via a bus or the like. The communication unit 304 is a communication interface connectable to the network N. The communication unit 304 communicates with an external device such as the mobile terminal 10, the device broker 20, or the clerk terminal 40 via the network N.

The storage unit 305 is a storage device such as an HDD, an SSD, or a flash memory, and maintains a stored content even when power is turned off. The storage unit 305 stores, for example, the control program 3051, a commodity master 3052, a device broker management table 3053, a shopping information management table 3054, and an association management table 3055.

The control program 3051 is for controlling the operations of the server apparatus 30. The control unit 300 (more specifically CPU 301) executes the control program 3051 to realize various functions.

The commodity master 3052 is a master file that stores commodity information related to commodities sold in the store. Specifically, the commodity master 3052 stores and manages a commodity name, a price, and the like in association with identification information for identifying each commodity.

FIG. 6 is a diagram illustrating an example of a data configuration of the commodity master 3052. As illustrated in FIG. 6, the commodity master 3052 stores commodity information about a commodity corresponding to a commodity code in association with the commodity code. Here, the commodity code is an example of the identification information for identifying the commodity. The commodity code can be, for example, a JAN code. The commodity information includes, for example, the commodity name, the type, and the price of the commodity.

The data configuration of the commodity master 3052 is not limited to FIG. 6. For example, the commodity master 3052 may include and store image data representing an appearance or a feature of the commodity in the commodity information.

Returning to FIG. 5, the device broker management table 3053 is a data table for managing the state of the device broker 20. Specifically, the device broker management table 3053 stores the device state information of each device DV connected to a device broker 20, in association with identification information for identifying the device broker 20. In general, there may be more than one device broker 20, and thus more than one device broker ID may be listed in the device broker management table 3053.

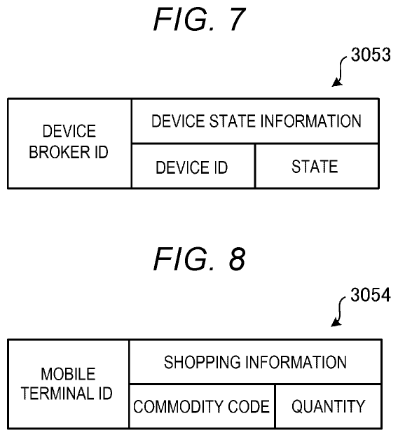

FIG. 7 is a diagram illustrating an example of a data configuration of the device broker management table 3053. As illustrated in FIG. 7, the device broker management table 3053 stores the device state information of the device(s) DV connected to the device broker 20 in association with a device broker ID for the particular device broker 20. Here, the device broker ID is an example of the identification information capable of identifying the device broker 20. For example, the device broker ID can be an IP address, a host name, or a unique identifier.

The device state information includes, for example, the device ID and the present state values as the device state information in a manner similar to that described for FIG. 4.

The data configuration of the device broker management table 3053 is not limited to FIG. 7. For example, the device broker management table 3053 may additionally store available settlement methods at the device broker 20 as determined by a support information providing unit 33 on the basis of the device state information.

Returning to FIG. 5, the shopping information management table 3054 is a data table for tracking commodities registered with the mobile terminal 10. Specifically, the shopping information management table 3054 stores shopping information indicating the details of the registered commodities that have been registered in the particular mobile terminal 10 associated with the identification information for identifying the mobile terminal 10.

FIG. 8 is a diagram illustrating an example of a data configuration of the shopping information management table 3054. As illustrated in FIG. 8, the shopping information management table 3054 stores the shopping information in association with a mobile terminal ID. Here, the mobile terminal ID is an example of the identification information for identifying a particular mobile terminal 10. For example, the mobile terminal ID can be an IP address, a host name, and/or a unique identifier.

The shopping information includes, for example, the commodity code and the quantity of each of the registered commodities. The data configuration of the shopping information management table 3054 is not limited to FIG. 8. For example, the shopping information management table 3054 may store additional commodity information corresponding to the commodity in association with the commodity code.

Returning to FIG. 5, the association management table 3055 is a data table for tracking the presently set association between a mobile terminal 10 and a device broker 20. Specifically, the association management table 3055 stores the identification information of a mobile terminal 10 in association with the identification information of a device broker 20.

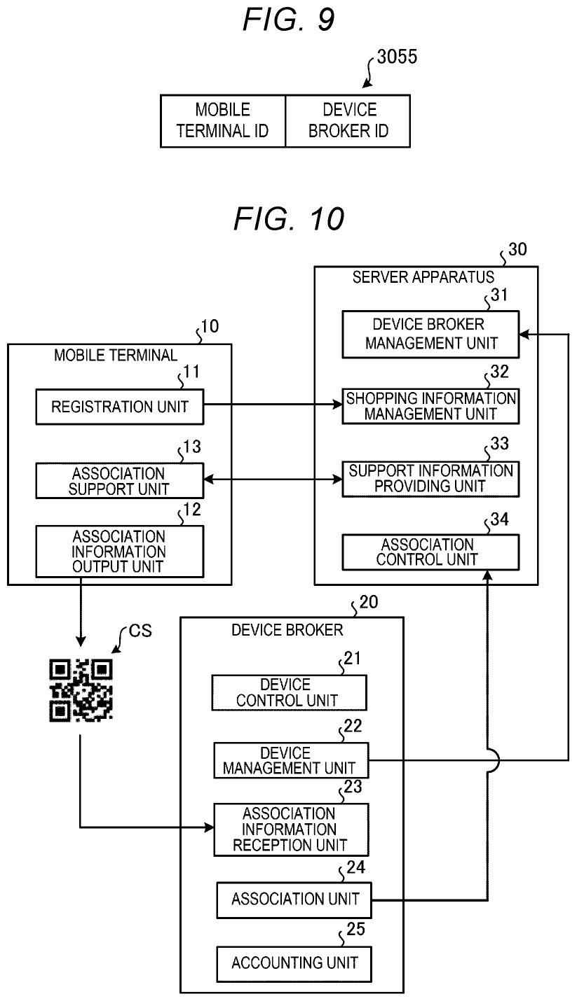

FIG. 9 is a diagram illustrating an example of a data configuration of the association management table 3055. As illustrated in FIG. 9, the association management table 3055 stores the mobile terminal ID of a mobile terminal 10 and the device broker ID of a device broker 20 in association with each other. That is, when a particular device broker 20 has been assigned to, designated by, or otherwise set to be associated with a particular mobile terminal 10, the corresponding mobile terminal ID and device broker ID are stored together in the association management table 3055. The server apparatus 30 of the present embodiment controls the relaying of information between a mobile terminal 10 and a device broker 20 by reference to the associated IDs in the association management table 3055.

The data configuration of the association management table 3055 is not limited to FIG. 9. For example, the association management table 3055 may also store a date and time indicating when the association relation was set.

Next, functional aspects of the mobile terminal 10, the device broker 20, and the server apparatus 30 will be described with reference to FIG. 10. Here, FIG. 10 is a diagram illustrating an example of the functional configurations of the mobile terminal 10, the device broker 20, and the server apparatus 30.

As illustrated in FIG. 10, the mobile terminal 10 provides a registration unit 11, an association information output unit 12, and an association support unit 13 as functional units. A part or all of the functional units of the mobile terminal 10 may have a software configuration implemented by cooperation between a processor (for example, the CPU 101) of the mobile terminal 10 and the control program 1051 stored in a memory (for example, the storage unit 105). In addition, a part or all of the functional units of the mobile terminal 10 may have a hardware configuration implemented by a dedicated circuit or the like mounted on the mobile terminal 10.

The device broker 20 provides a device control unit 21, a device management unit 22, an association information reception unit 23, an association unit 24, and an accounting unit 25 as functional units. A part or all of the functional units of the device broker 20 may have a software configuration implemented by cooperation between a processor (for example, the CPU 201) of the device broker 20 and the control program 2061 stored in a memory (for example, the storage unit 206). In addition, a part or all of the functional units of the device broker 20 may have a hardware configuration implemented by a dedicated circuit or the like mounted on the device broker 20.

The server apparatus 30 provides a device broker management unit 31, a shopping information management unit 32, a support information providing unit 33, and an association control unit 34 as functional units. A part or all of the functional units of the server apparatus 30 may have a software configuration implemented by cooperation between a processor (for example, the CPU 301) of the server apparatus 30 and the control program 3051 stored in a memory (for example, the storage unit 305). In addition, a part or all of the functional units of the server apparatus 30 may have a hardware configuration implemented by a dedicated circuit or the like mounted on the server apparatus 30.

First, functions related to state management of the devices DV connected to each of the device brokers 20 will be described.

The device control unit 21 of the device broker 20 controls an operation of a device DV connected to the device broker 20. Specifically, the device control unit 21 controls the operation of a device DV for a mobile terminal 10 in cooperation with a device driver and the like introduced in advance.

The device management unit 22 of the device broker 20 monitors the state of the device DV connected to the device broker 20 and stores the state in the device management table 2062. Specifically, the device management unit 22 confirms the state for each connected device DV and stores the confirmed device state information in association with the corresponding device ID in the device management table 2062.

In addition, the device management unit 22 transmits the device state information stored in the device management table 2062 to the server apparatus 30. Specifically, the device management unit 22 transmits the device state information to the server apparatus 30 together with the device broker ID of the device broker 20.

The device management unit 22 may transmit device state information indicating a reason why a device DV is in an unusable state. The timing at which the device management unit 22 confirms the device state and the timing at which the device management unit 22 transmits the device state information to the server apparatus 30 are not particularly limited, but it is preferable to periodically perform checks and updates so the device state information will reflect real-time performance. In addition, the device control unit 21 may be configured to include a function of the device management unit 22.

The device broker management unit 31 of the server apparatus 30 is an example of a collection unit. The device broker management unit 31 collects the device state information transmitted from the device broker(s) 20 and stores the device state information in the device broker management table 3053. Specifically, when receiving the device state information from each of several device brokers 20, the device broker management unit 31 stores the device state information in association with the relevant device broker IDs in the device broker management table 3053. More specifically, the device broker management unit 31 updates the device state information stored in association with the device broker ID on the basis of the received device state information.

By the cooperation between the device broker 20 and the server apparatus 30, a latest state of the devices DV connected to each of the device brokers 20 is recorded in the device broker management table 3053.

The registration unit 11 of the mobile terminal 10 executes the registration of the commodity being purchased by the customer. Specifically, the registration unit 11 reads a commodity code attached to the commodity being purchased by the customer from an image of the commodity captured by the imaging unit 108, in response to an operation of the customer. More specifically, the registration unit 11 detects the code symbol in the captured image and decodes the detected code symbol to acquire a commodity code encoded in the code symbol.

The registration unit 11 identifies a commodity corresponding to the acquired commodity code by reference to the commodity master 3052 of the server apparatus 30. The registration unit 11 causes the display unit 106 to display commodity information of the identified commodity to notify the operator of the registered commodity.

Then, the registration unit 11 transmits shopping information related to accounting of the identified commodity to the server apparatus 30 together with the mobile terminal ID of the mobile terminal 10 to register the shopping information in the shopping information management table 3054. Here, the shopping information includes, for example, information indicating details of the commodity to be purchased such as the commodity code and the quantity of the commodity being purchased. The quantity value may be separately input via the operation unit 107, or may be the accumulated number of the same commodity code input to the mobile terminal 10.

The shopping information management unit 32 of the server apparatus 30 stores the shopping information transmitted from the mobile terminal 10 in the shopping information management table 3054. Specifically, when receiving a combination of the mobile terminal ID and the shopping information from the mobile terminal 10, the shopping information management unit 32 stores the combination in an associated manner in the shopping information management table 3054.

By the cooperation between the mobile terminal 10 and the server apparatus 30, the shopping information of the commodity read by the mobile terminal 10 is registered in the shopping information management table 3054 of the server apparatus 30.

The association information output unit 12 of the mobile terminal 10 outputs association information related to an association with a device broker 20. The association information also includes the identification information of the mobile terminal 10. Specifically, when receiving an operation for instructing an end of the registration of the commodity, that is, an operation for starting the accounting (transaction settlement process), the association information output unit 12 causes the display unit 106 to display the association information including the mobile terminal ID of the mobile terminal 10. Here, the association information is output as a code symbol CS such as a two-dimensional code.

The association information reception unit 23 receives the association information via a device DV connected to the device broker 20. Specifically, the association information reception unit 23 receives the association information from the code reading device DVa.

The association unit 24 notifies the server apparatus 30 of the association information received by the association information reception unit 23. Specifically, the association unit 24 transmits the device broker ID of the device broker 20 to the server apparatus 30 together with the association information to instruct an association to be registered between the device broker 20 and the mobile terminal 10 identified in the association information. Accordingly, the server apparatus 30 begins relaying of information, data, commands, or the like between the associated device broker 20 and the mobile terminal 10 under control of the association control unit 34.

The association control unit 34 of the server apparatus 30 is an example of a relaying unit. The association control unit 34 controls the association between the mobile terminal 10 and the device broker 20. When receiving a combination of the device broker ID and the association information from the device broker 20, the association control unit 34 registers the combination in the association management table 3055. Specifically, the association control unit 34 registers the received device broker ID and the mobile terminal ID included in the association information in the association management table 3055.

In addition, the association control unit 34 relays information, data, commands, or the like between the mobile terminal 10 and the device broker 20 on the basis of information registered in the association management table 3055.

With the configuration described above, association information provided by the mobile terminal 10 is read by the code reading device DVa of a particular device broker 20. Therefore, by the cooperation between the device broker 20 and the server apparatus 30, the mobile terminal 10 and the device broker 20 become associated with each other, and communication between the two devices can be relayed by the server apparatus 30 rather than conducted directly. Accordingly, in the checkout system 1, information related to the accounting and the like of the commodities registered in the mobile terminal 10 can be input and output using a device DV of the device broker 20.

The association support unit 13 of the mobile terminal 10 supports operations and processes related to the association with the device broker 20. For example, the association support unit 13 requests the server apparatus 30 provide information related to the device brokers 20 (also referred to as sending an association support request) in response to a user operation of starting the accounting or the like. In addition, the association support unit 13 acquires information (“association support information”) indicating the state of the device brokers 20 from the server apparatus 30 in response to the association support request. Then, the association support unit 13 causes the display unit 106 to display a screen (“an association support screen”) based on the acquired association support information).

The support information providing unit 33 provides the association support information to the mobile terminal 10 in response to the association support request from the mobile terminal 10. Specifically, the support information providing unit 33 generates the association support information on the basis of the device broker management table 3053 and the association management table 3055. Then, the support information providing unit 33 transmits the generated association support information to the requesting mobile terminal 10.

As an example, the support information providing unit 33 determines whether each of the device brokers 20 is presently in use, in an idle state, in an unusable state, or the like on the basis of the information registered in the device broker management table 3053 and the association management table 3055. Then, the support information providing unit 33 generates the association support information including an indication as to whether a device broker 20 can be used.

Specifically, the support information providing unit 33 determines whether a device broker 20 can be used on the basis of the state of each device DV registered in the device broker management table 3053. For example, when an abnormality occurs in the code reading device DVa used for inputting the association information, the support information providing unit 33 determines that the corresponding device broker 20 is in the unusable state. In addition, the support information providing unit 33 determines that the device brokers 20 registered in the association management table 3055 are presently in use and that the device brokers 20 not registered in the association management table 3055 are in the idle state. However, when a particular device broker 20 is determined to be in both the unusable state and the idle state (or in use), the unusable state is prioritized.

As another example, the support information providing unit 33 may also determines which settlement methods are available at a device broker 20 on the basis of the states of each device DV registered in the device broker management table 3053 in association with the device broker 20. Then, the support information providing unit 33 generates the association support information including an indication of available settlement methods for each device broker 20 or the like.

Specifically, the support information providing unit 33 determines the usable settlement methods on the basis of the states of the devices DV connected to the device broker 20 that must be used in the specific payment methods. For example, when the cash recycler DVe is in the usable state, the support information providing unit 33 determines that cash settlement is possible. When the code reading device DVa is in the usable state, the support information providing unit 33 determines that electronic settlement using a two-dimensional code (hereinafter, also referred to as code settlement) is possible. When the wireless tag reading device DVb is in the usable state, the support information providing unit 33 determines that electronic settlement using a wireless tag (hereinafter, also referred to as RFID settlement) is possible. When the card settlement device DVd is in the usable state, the support information providing unit 33 determines that settlement using a credit card (hereinafter, also referred to as credit settlement) is possible.

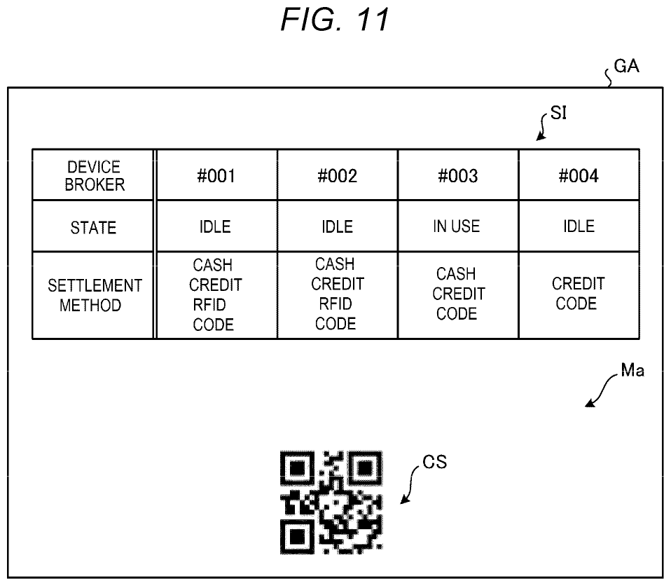

The association support unit 13 may also cause the display unit 106 to display, for example, an association support screen as illustrated in FIG. 11 on the basis of the support information provided from the server apparatus 30. Here, FIG. 11 is a diagram illustrating one example of the association support screen.

As illustrated in FIG. 11, support information SI provided from the server apparatus 30 is displayed on an association support screen GA. Here, the support information SI includes states of four device brokers 20 whose device broker IDs are #001 to #004. Specifically, as the states of the device brokers 20, FIG. 11 illustrates that the device brokers 20 #001, #002, and #004 are in the idle state and the device broker 20 #003 is in use. In addition, as the settlement methods that can be used in the device brokers 20, FIG. 11 illustrates that the device brokers 20 #001 and #002 support cash settlement, credit settlement, RFID settlement, and code settlement. In addition, FIG. 11 illustrates that the device broker 20 #003 supports cash settlement, credit settlement, and code settlement, but the device broker 20 #004 supports just credit settlement and code settlement.

The operator of the mobile terminal 10 can easily grasp which device broker 20 can be used for a preferred settlement method and is also presently in the idle state by viewing the support information SI. Accordingly, the checkout system 1 can support the operator of the mobile terminal 10 to select a particular device broker 20 as an association target.

In addition, the association support screen GA of FIG. 11 displays the code symbol CS which is the association information generated by the association information output unit 12, and also a message Ma for prompting the operator to scan or otherwise input the code symbol CS at a device broker 20.

Accordingly, the operator of the mobile terminal 10 can easily grasp that the code symbol CS is to be scanned at the device broker 20 selected on the basis of the support information SI. Therefore, convenience for the operator of the mobile terminal 10 can be improved in the checkout system 1.

The association support screen GA is not limited to the example of FIG. 11. For example, in FIG. 11, the code symbol CS and the massage Ma are displayed on the association support screen GA, but the code symbol CS and the massage Ma may also be displayed on another screen. In addition, the association information output unit 12 may include functions of the association support unit 13.

The present embodiment is an example in which the device broker 20 executes the accounting process.

The accounting unit 25 of the device broker 20 executes the accounting for the commodities registered in an associated mobile terminal 10. Specifically, the accounting unit 25 acquires, from the server apparatus 30, shopping information in association with the identification information included in the association information received by the association information reception unit 23. More specifically, the accounting unit 25 transmits an acquisition request of the shopping information, which specifies the mobile terminal ID included in the association information, to the server apparatus 30.

When receiving the acquisition request of the shopping information from the device broker 20, the shopping information management unit 32 of the server apparatus 30 provides the shopping information specified by the acquisition request to the device broker 20. Specifically, the shopping information management unit 32 extracts the shopping information corresponding to the specified mobile terminal ID from the shopping information management table 3054. Then, the shopping information management unit 32 transmits the extracted shopping information to the device broker 20 as the request source.

After acquiring the shopping information from the server apparatus 30, the accounting unit 25 of the device broker 20 calculates a total amount due for the registered commodities on the basis of the commodity codes and quantities of each commodity included in the shopping information. Specifically, the accounting unit 25 identifies the commodity information by commodity code by referencing the commodity master 3052 of the server apparatus 30. Next, the accounting unit 25 multiplies the price included in the identified commodity information by the quantity, and adds up the amounts due for each commodity to calculate the total amount due for the registered commodities. Upon receiving a payment via a device DV connected to the device broker 20, the accounting unit 25 executes the accounting for settling the total amount according to the received payment amount.

In addition, when the accounting is completed, the accounting unit 25 causes the printer DVc connected to the device broker 20 to issue a receipt on which information indicating the registered commodities and the content of the settlement are printed. When the accounting is completed, the accounting unit 25 notifies the server apparatus 30 of the completion of the accounting. Specifically, the accounting unit 25 transmits the completion notification of the accounting, which specifies the association information or the mobile terminal ID included in the association information, to the server apparatus 30.

Upon receiving the completion notification of the accounting from the device broker 20, the shopping information management unit 32 of the server apparatus 30 excludes (e.g., deletes, removes, or invalidates) the shopping information for which the accounting has just been completed from the shopping information management table 3054. Specifically, the shopping information management unit 32 excludes an entry of the shopping information (for example, the mobile terminal ID and the shopping information) associated with the association information (or the identification information) specified by the completion notification from the shopping information management table 3054. Here, in this example, “exclude” means deleting from the shopping information management table 3054, moving to another table, or attaching a flag or the like to distinguish from an unaccounted entry.

After receiving the completion notification of the accounting from the device broker 20, the association control unit 34 of the server apparatus 30 cancels the association of the device broker 20 and the mobile terminal 10. Specifically, when receiving the completion notification of the accounting from the device broker 20, the association control unit 34 deletes an entry related to the device broker ID of the device broker 20 from the association management table 3055.

Accordingly, the operator of the mobile terminal 10 can pay for the registered commodities using the devices DV connected to a device broker 20. Therefore, in the checkout system 1, the commodities registered with the mobile terminal 10 can be paid for using a device DV without establishing direct communication between the mobile terminal 10 and the device broker 20, and thus the convenience for the operator of the mobile terminal 10 can be improved.

The accounting unit 25 may provide information or a screen indicating a process state of the accounting to the mobile terminal 10 via the server apparatus 30. In this case, the association support unit 13 of the mobile terminal 10 causes the display unit 106 of the mobile terminal 10 to display the information or a screen indicating the process state of the accounting as provided from the server apparatus 30. In addition, for example, the accounting unit 25 may provide the mobile terminal 10 with a screen for announcing a settlement method supported by the device broker 20 or a selection screen for selecting a desired settlement method to be used, on the basis of the state of each device DV stored in the device management table 2062.

Accordingly, the operator of the mobile terminal 10 can easily grasp the process state of the accounting by viewing the display unit 106 of the mobile terminal 10. Therefore, the checkout system 1 can improve the convenience for the operator of the mobile terminal 10 related to the accounting.

The device control unit 21 of the device broker 20 may control switching of an operation mode of a device DV connected to the device broker 20 in accordance with a state of the association with the mobile terminal 10. For example, when not associated with a mobile terminal 10, the device control unit 21 may cause the devices DV other than the code reading device DVa to shift to an idle state such as a power saving mode. In addition, when the association with the mobile terminal 10 is started by the association unit 24, the device control unit 21 causes the devices DV in the standby state to shift to a normal state (also referred to as an active state), and brings all the devices DV into a usable state. When the accounting unit 25 provides the selection screen of the settlement method to the mobile terminal 10, the device control unit 21 may cause a device DV related to the selected payment method to shift to the active state.

Accordingly, when the device broker 20 is not in association with the mobile terminal 10, a power consumption of the device DV connected to the device broker 20 can be reduced, and thus power saving can be achieved.

Next, an operation example of the checkout system 1 described above will be described.

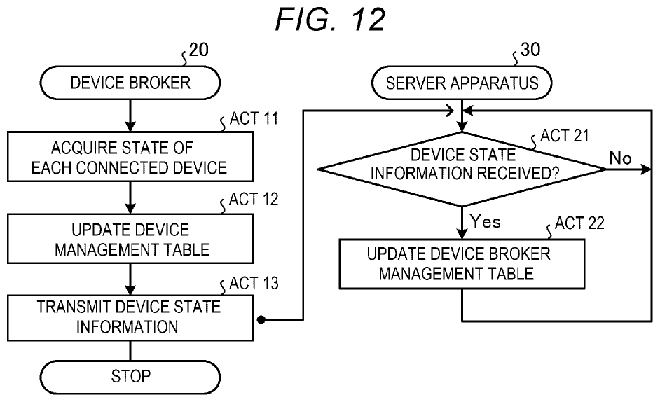

First, the device state management executed by the device broker 20 and the server apparatus 30 will be described with reference to FIG. 12. FIG. 12 is a flowchart illustrating an example of the device state management executed by the device broker 20 and the server apparatus 30.

First, the device management unit 22 of the device broker 20 acquires the state of each device DV connected to the device broker 20 (Act 11). The device management unit 22 updates the device state information of the device management table 2062 on the basis of the acquired state of the device DV (Act 12). Next, the device management unit 22 transmits the updated device state information to the server apparatus 30 (Act 13).

The device broker management unit 31 of the server apparatus 30 waits (Act 21; No) until the device state information is received from the device broker 20. Upon receiving the device state information (Act 21; Yes), the device broker management unit 31 stores the received device state information in the device broker management table 3053 in association with the device broker ID of the device broker 20 to update the device state information (Act 22).

The processes in Acts 11 to 13 are executed by each of the device brokers 20, whereby the state of each device DV connected to each of the device brokers 20 is registered in the device broker management table 3053 of the server apparatus 30.

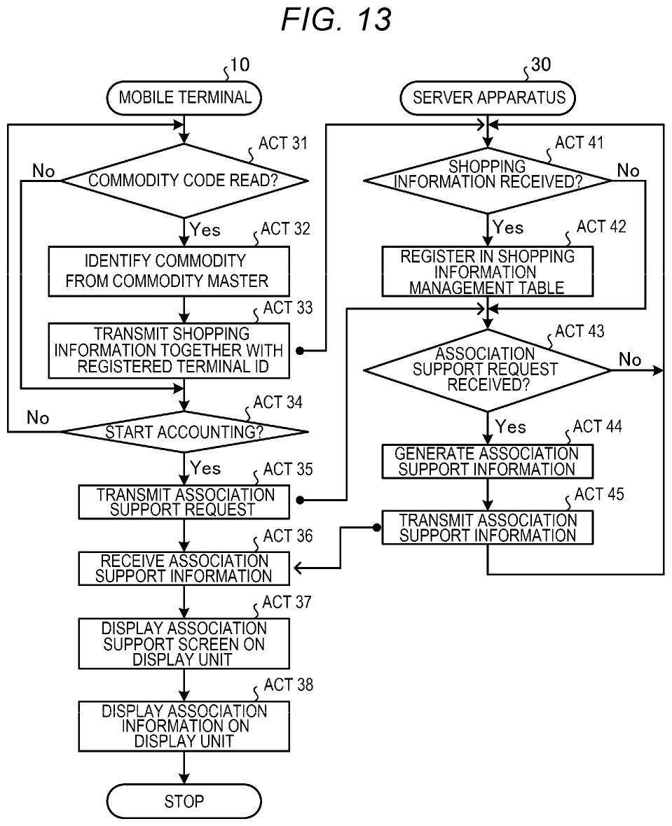

Next, the commodity registration executed by the mobile terminal 10 and the server apparatus 30 will be described with reference to FIG. 13. FIG. 13 is a flowchart illustrating an example of the commodity registration executed by the mobile terminal 10 and the server apparatus 30.

First, in the mobile terminal 10, when the registration of the commodity is started by the operation of the operator, the registration unit 11 determines whether the commodity code is read from the image captured by the imaging unit 108 (Act 31). When the commodity code cannot be read (Act 31; No), the process proceeds to Act 34.

In Act 31, when the commodity code is read (Act 11; Yes), the registration unit 11 identifies the commodity corresponding to the commodity code by reference to the commodity master 3052 of the server apparatus 30 (Act 32). Next, the registration unit 11 transmits the shopping information for the identified commodity to the server apparatus 30 together with the mobile terminal ID of the mobile terminal 10 (Act 33), and the process proceeds to Act 34.

The shopping information management unit 32 of the server apparatus 30 determines whether the shopping information has been received from the mobile terminal 10 (Act 41). Here, when the shopping information management unit 32 does not receive the shopping information (Act 41; No), the process proceeds to Act 43.

When the shopping information has been received from the mobile terminal 10 (Act 41; Yes), the shopping information management unit 32 registers the received mobile terminal ID and shopping information in the shopping information management table 3054 in association with each other (Act 42), and the process proceeds to Act 43.

In the mobile terminal 10, after Act 33, the registration unit 11 determines whether the start of the accounting has been instructed via the operation unit 107 (Act 34). Here, if the start of the accounting is not yet instructed (Act 34; No), the process returns to Act 31. If the start of the accounting has been instructed (Act 34; Yes), the association support unit 13 transmits the association support request to the server apparatus 30 (Act 35).

The support information providing unit 33 of the server apparatus 30 determines whether the association support request has been received from the mobile terminal 10 (Act 43). Here, if the association support request is not yet received (Act 43; No), the process returns to Act 41. If the association support request has been received from the mobile terminal 10 (Act 43; Yes), the support information providing unit 33 generates the association support information (Act 44) and transmits the generated association support information to the requesting mobile terminal 10 (Act 45).

Upon receiving the association support information from the server apparatus 30 as a response to the association support request (Act 36), the association support unit 13 of the mobile terminal 10 causes the display unit 106 to display the association support screen GA on the basis of the association support information (Act 37).

Next, the association information output unit 12 of the mobile terminal 10 generates the association information including the mobile terminal ID of the mobile terminal 10 and causes the display unit 106 to display the association information (Act 38).

The processes at Acts 31 to 38 are executed by the mobile terminal 10, so that the association information for associating with the device broker 20 is displayed on the display unit 106. The operator of the mobile terminal 10 moves to a desired device broker 20 (e.g., selected on the basis of the association support screen GA) and causes a code reading device DVa to read the association information, thereby starting the association between the mobile terminal 10 and the device broker 20.

In some examples, the mobile terminal 10 may display the association information immediately after receiving the instruction to start the accounting in Act 34 by skipping Acts 35 to 37. In this case, the association support request may be transmitted in response to a predetermined operation via the operation unit 107 other than the accounting instruction. In addition, the mobile terminal 10 might not transmit an association support request or display an association support screen.

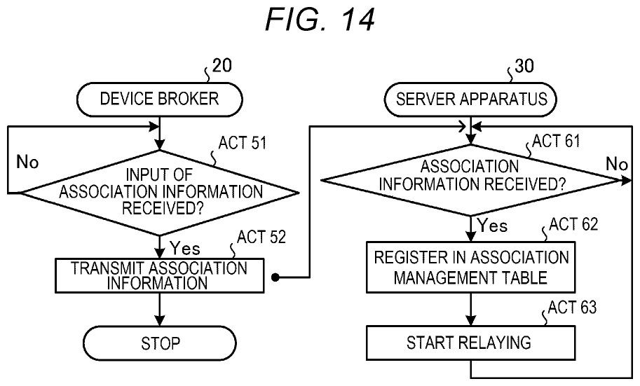

Next, the association executed by the device broker 20 and the server apparatus 30 will be described with reference to FIG. 14. FIG. 14 is a flowchart illustrating an example of the association executed by the device broker 20 and the server apparatus 30.

First, the association information reception unit 23 of the device broker 20 waits (Act 51; No) until the association information is input via the code reading device DVa. When the association information is input (Act 51; Yes), the association information reception unit 23 transmits the association information to the server apparatus 30 together with the device broker ID of the device broker 20 (Act 52).

The association control unit 34 of the server apparatus 30 waits (Act 61; No) until the association information is transmitted from the device broker 20. When the association information is received (Act 61; Yes), the association control unit 34 registers the mobile terminal ID included in the received device association information in the association management table 3055 in association with the device broker ID of the device broker 20 as the transmission source (Act 62). Next, the association control unit 34 starts the relaying between the mobile terminal 10 and the device broker 20 which are now registered in the association management table 3055 (Act 63).

Through the association described above, information can be exchanged between the mobile terminal 10 and the device broker 20 via the server apparatus 30. Accordingly, in the checkout system 1, information with respect to the mobile terminal 10, for example, information related to the accounting of the commodity can be input and output using the devices DV connected to the device broker 20.

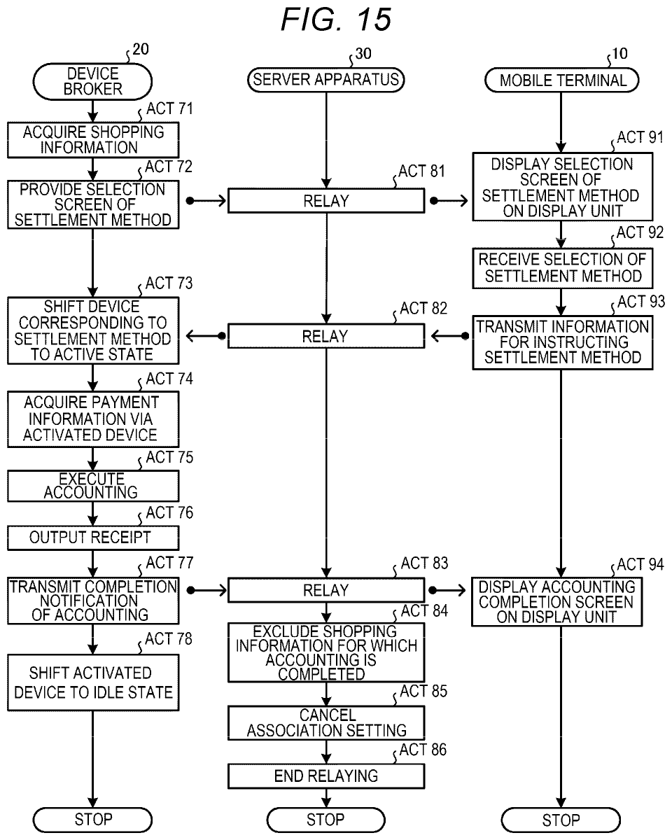

Next, the associated accounting executed by the mobile terminal 10, the device broker 20, and the server apparatus 30 will be described with reference to FIG. 15. FIG. 15 is a flowchart illustrating an example of the associated accounting executed by the mobile terminal 10, the device broker 20, and the server apparatus 30. The present process includes a process executed by the mobile terminal 10 and the device broker 20 that are in the association relation after the association illustrated in FIG. 14.

First, the accounting unit 25 of the device broker 20 acquires the shopping information related to the mobile terminal 10 of the association target (Act 71). Specifically, the accounting unit 25 transmits, to the server apparatus 30, an acquisition request for the shopping information in which the mobile terminal ID of the mobile terminal 10 of the association target is specified, thereby acquiring the corresponding shopping information from the server apparatus 30.

Next, the accounting unit 25 transmits, to the server apparatus 30, a selection screen on which a desired settlement method can be selected from settlement methods supported by the device broker 20 on the basis of the state of each device DV stored in the device management table 2062 (Act 72). The selection screen transmitted from the accounting unit 25 is relayed to the associated mobile terminal 10 by the association control unit 34 of the server apparatus 30 (Act 81). Then, when receiving the selection screen via the server apparatus 30, the association support unit 13 of the mobile terminal 10 causes the display unit 106 to display the selection screen (Act 91).

When receiving the selection of the settlement method via the selection screen (Act 92), the association support unit 13 of the mobile terminal 10 transmits instruction information for instructing the received settlement method to the server apparatus 30 (Act 93). The instruction information transmitted from the mobile terminal 10 is relayed to the associated device broker 20 by the association control unit 34 of the server apparatus 30 (Act 82).

When receiving the instruction information for instructing the settlement method via the server apparatus 30, the device control unit 21 of the device broker 20 causes the device(s) DV related to the instructed settlement method to shift to the active state (Act 73). Next, the accounting unit 25 of the device broker 20 acquires payment information indicating the payment amount via a device DV activated at Act 73 (Act 74), and executes the accounting (Act 75).

Next, when the accounting is completed, the accounting unit 25 of the device broker 20 outputs the receipt from the printer DVc (Act 76). In addition, the accounting unit 25 transmits the completion notification of the accounting to the server apparatus 30 (Act 77).

The completion notification of the accounting transmitted from the accounting unit 25 is relayed to the associated mobile terminal 10 by the association control unit 34 of the server apparatus 30 (Act 83). Then, when receiving the completion notification of the accounting via the server apparatus 30, the association support unit 13 of the mobile terminal 10 causes the display unit 106 to display an accounting completion screen indicating that the accounting is completed (Act 94).

The shopping information management unit 32 of the server apparatus 30 excludes an entry of the corresponding shopping information from the shopping information management table 3054 in response to the completion notification of the accounting (Act 84). The association control unit 34 of the server apparatus 30 cancels an association setting related to the notifying device broker 20 in response to the completion notification of the accounting (Act 85) and ends the relaying between the mobile terminal 10 and the device broker 20 (Act 86).

When the accounting is completed, the device control unit 21 of the device broker 20 causes the device DV activated in Act 73 to shift to the idle state (Act 78), and ends the process.

Through the associated accounting described above, the operator of the mobile terminal 10 can pay for the registered commodities using a device DV of an associated device broker 20. Accordingly, in the checkout system 1, the commodities registered in the mobile terminal 10 can be paid for using various devices DV without establishing any direct communication between the mobile terminal 10 and the device broker 20, and thus the convenience for the operator of the mobile terminal 10 can be improved.

As described above, in the checkout system 1 of the present embodiment, the association information displayed on the display unit 106 of the mobile terminal 10 is taken in by the code reading device DVa connected to the device broker 20, so that information can be subsequently exchanged between the mobile terminal 10 and the device broker 20 via relay through the server apparatus 30. Accordingly, in the checkout system 1, the commodities can be paid for using a device DV without directly connecting the mobile terminal 10 to a device DV, and thus the devices DV can be more easily used.

In addition, the checkout system 1 of the present embodiment provides the mobile terminal 10 with the association support information for supporting the association with the device broker 20 at a timing when the commodity registration in the registered 10 is completed. Accordingly, in the checkout system 1, the operator of the mobile terminal 10 can provide information to be referred to when selecting the device broker 20, and thus convenience related to the selection of the device broker 20 can be improved.

The above-described embodiment can be modified in various aspects. Furthermore, the various modifications described below may be implemented individually or in combination with one another as appropriate.

(First Modification)

In the embodiment described above, the mobile terminal ID of the mobile terminal 10 is used as the identification information for identifying the mobile terminal 10, but is not limited thereto. For example, identification information such as an ID or a name of the operator who operates the mobile terminal 10 may be used as the identification information for identifying the mobile terminal 10.

In addition, identification information for identifying a transaction related to the purchase of the commodities registered in the mobile terminal 10 may be used as the identification information for identifying the mobile terminal 10. Here, a “transaction” refers to a period from the start to the end of the registration of the commodity for the same customer. For example, when a unique transaction ID is issued every time the operation of starting the registration of the commodities is performed in the mobile terminal 10, each of the mobile terminals 10 can be uniquely identified using transactions ID.

The identification information of the operator or the transaction may be used instead of the mobile terminal ID of the mobile terminal 10, and may be used together with the mobile terminal ID. Accordingly, similar to the embodiment described above, the association with the device broker 20 can be set on the basis of the identification information of the operator or the transaction, and the shopping information can be acquired, and thus effects similar to those of the embodiment described above can be achieved.

(Second Modification)

In the embodiment described above, the shopping information of the commodities registered in the mobile terminal 10 is stored by the server apparatus 30, but is not limited thereto, and may also or instead be stored by the mobile terminal 10. In this case, the registration unit 11 of the mobile terminal 10 registers the commodity by storing the shopping information of the commodity read by the imaging unit 108 in the RAM 103 or the storage unit 105.

The accounting unit 25 of the device broker 20 may thus acquire the shopping information from an associated mobile terminal 10 via the server apparatus 30. Then, when receiving the completion notification of the accounting from the device broker 20, via the server apparatus 30, the registration unit 11 of the mobile terminal 10 deletes (or otherwise excludes) the shopping information registered in the RAM 103 or the storage unit 105.

When the configuration according to the present modification is employed, the checkout system 1 can also receive payments for the registered commodity by using a device DV without directly connecting the mobile terminal 10 and the device DV, and thus effects similar to those of described above can be achieved.

(Third Modification)

In an embodiment described above, each device broker 20 is connected to devices DV of types and numbers corresponding to the configuration of an accounting machine (e.g., a self-service point-of-sale terminal, a semi-self-service checkout machine, a checkout kiosk, or the like), but is not limited to this form. In other examples, one device broker 20 may be connected to devices DV of types and numbers corresponding to a plurality of accounting machines. In this case, each device broker 20 can be used by a plurality of operators in parallel, but it is still typically preferable to divide the devices DV into groups (sets) corresponding to the configuration of a single accounting machine so that the devices DV do not conflict with each other in use.

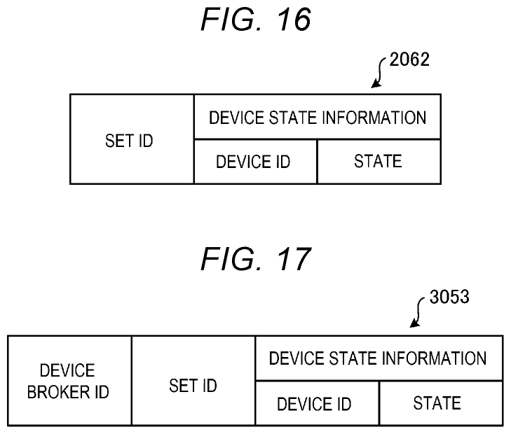

In such a case, the device management unit 22 of the device broker 20 may track the state of each device DV using the device management table 2062 illustrated in FIG. 16. Here, FIG. 16 is a diagram illustrating an example of the data configuration of the device management table 2062 according to a third modification.

As illustrated in FIG. 16, in the device management table 2062, the device state information of each device DV is managed as groups (sets) of devices DV with each group (set) corresponding to the configuration of a one accounting machine. Here, a set ID is used as identification information of a virtual accounting machine or the like corresponding to a particular group (set) of devices DV. That is, devices DV with the same set ID are managed by device ID as components of a virtual accounting machine corresponding to the set ID. When transmitting the device state information to the server apparatus 30, the device management unit 22 also transmits the corresponding set ID to the server apparatus 30 in association with the device state information.

In addition, in this case, the device broker management unit 31 of the server apparatus 30 manages the state of each device DV connected to each device broker 20 using, for example, the device broker management table 3053 illustrated in FIG. 17. Here, FIG. 17 is a diagram illustrating an example of the data configuration of the device broker management table 3053 according to the third modification.

As illustrated in FIG. 17, the device broker management table 3053 stores the set ID and the device state information in association with the device broker ID of the device broker 20. That is, the device broker management table 3053 tracks the state of the devices DV in each device broker 20 by set ID.

In this case, the association unit 24 of the device broker 20 transmits a set ID to which the code reading device DVa input with the association information belongs to the server apparatus 30 together with the association information. Then, the association control unit 34 of the server apparatus 30 associates the identification information of the mobile terminal 10 and the device broker 20 and registers the identification information in the association management table 3055 and also registers the set ID transmitted together with the association information in the association management table 3055.

Accordingly, in the present modification, among the devices DV connected to the device broker 20, a device DV of the set ID registered in the association management table 3055 can be used for the accounting and the like. That is, in the present modification, when a plurality of sets (virtual accounting machines) formed of the devices DV connected to a single device broker 20, each set can be separately associated with a mobile terminal 10.

The sets of the devices DV connected to the device broker 20 are preferably grouped separately from one another or otherwise provided with an identifying label or the like displaying the respective set ID to which the device DV belongs so as prevent confusion between the sets.

(Fourth Modification)

An embodiment described above described an example in which the state of the device DV connected to the device broker 20 is detected as the unusable state due to a failure or the like. In this case, the server apparatus 30 may notify the clerk terminal 40 of the presence of a device DV in the unusable state.

For example, the device broker management unit 31 of the server apparatus 30 monitors the device state information transmitted from the device brokers 20 and determines whether any device DV in the unusable state is included therein. When detecting a device DV in the unusable state in the device state information, the device broker management unit 31 transmits the device broker ID of the relevant device broker 20 and the device ID of the device DV in the unusable state to the clerk terminal 40 as error information.

Upon receiving the error information from the server apparatus 30, the clerk terminal 40 notifies the clerk of the presence of the device DV in the unusable state by, for example, displaying or otherwise notifying that error information has been received. Accordingly, the clerk operating the clerk terminal 40 can easily identify the device DV in the unusable state by confirming the error information transmitted from the server apparatus 30.

In the case of a configuration in which the unusable state is recorded along with the cause thereof, the device broker management unit 31 preferably transmits the error information to the clerk terminal 40 including the cause. Accordingly, the clerk operating the clerk terminal 40 can identify the cause of the unusable state, and thus the convenience can be improved.

When the clerk responds by, for example, replacing or repairing the device DV previously in the unusable state, the device management unit 22 of the device broker 20 updates the device state information of the corresponding device DV. Accordingly, a state of the device DV after the response can be promptly reflected in the device management table 2062 and the device broker management table 3053.

When the device ID is changed due to the replacement or the like of the device DV, the device management unit 22 of the device broker 20 updates the device state information using the changed device ID.

As described above, by employing the present modification, even when the device DV is in the unusable state, the device DV can be rapidly handled, and thus an efficiency of the entire checkout system 1 can be improved.

Programs executed in each apparatus of an embodiment can be provided by being incorporated in a ROM, a storage device, or the like in advance. The programs executed by each apparatus of an embodiment may be provided by being recorded in a non-transitory, computer-readable recording medium such as a CD-ROM, a flexible disk (FD), a CD-R, or a digital versatile disk (DVD) in an installable or executable form of a file.

Further, the programs executed by each apparatus described above may be stored on a computer connected to a network, such as the Internet, and downloaded via the network. In addition, the programs executed by each apparatus of the embodiment described above may be accessed or distributed across a network, such as the Internet.

The embodiments of the disclosure have been described, but these embodiments are merely presented as examples, and are not intended to limit the scope of the disclosure. Such new exemplary embodiments and modifications thereof can be implemented in other various forms, and various omissions, replacements, and changes can be made without departing from the spirit of the exemplary embodiments described herein. The embodiments and modifications thereof are included in the scope and gist of the exemplary embodiments described herein, and are also included in the exemplary embodiments described in the claims and equivalents thereof.

What is claimed is:

1. An information processing apparatus, comprising:
a device connection unit configured to allow a plurality of devices to be detachably connected thereto;
a network communication interface configured to communicate with a server apparatus;
a processor configured to:
receive from the device connection unit an input of first identification information from a first device connected to the device connection unit, the first identification information identifying a particular mobile terminal connected to the network;
notify the server apparatus, via the network communication interface, of an association between the first identification information and second identification information of the information processing apparatus to cause the server apparatus to relay information between the particular mobile terminal and the information processing apparatus; and
execute accounting processing for a commodity registered by the particular mobile terminal, the accounting processing using one or more devices connected to the device connection unit.

2. The information processing apparatus according to claim 1, wherein the first device is a code reader and the first identification information is decoded from a code symbol read by the first device.

3. The information processing apparatus according to claim 1, wherein
the processor is configured to acquire, via the network communication interface, shopping information associated with the first identification information in the server apparatus, the shopping information including details of commodities registered for purchase with the mobile terminal, and
the accounting processing being executed on the basis of the acquired shopping information.

4. The information processing apparatus according to claim 1, wherein
the device connection unit is connected to a settlement device configured to receive a payment associated with the accounting processing.

5. The information processing apparatus according to claim 1, wherein the device connection unit is connected to a cash handler device configured to receive a payment associated with the accounting processing and return change associated with the payment.

6. The information processing apparatus according to claim 1, wherein
the plurality of peripheral devices connected to the device connection unit includes a first group and a second group,
the first group being associated with second information of a first version and the second group being associated with second information of a second version distinguishable from the first version.

7. The information processing apparatus according to claim 1, wherein the device connection unit includes a plurality of connectors for connecting to the plurality of devices.

8. The information processing apparatus according to claim 1, wherein the information processing apparatus is a self-service point-of-sale terminal.

9. A server apparatus for a store checkout system, the server apparatus comprising:
a storage unit;
a network communication interface configured to communicate with a mobile terminal and a device broker detachably connected a plurality of peripheral devices; and
a processor configured to:
collect operating states of the plurality of peripheral devices connected to the device broker and store the collected operating states in the storage unit,
provide the mobile terminal with information indicating a state of the device broker on the basis of the collected operating states of the peripheral devices connected to the device broker,
relay information between the mobile terminal and the device broker upon receiving an association instruction from the device broker, the association instruction including first identification information of the mobile terminal and second identification information of the device broker, and provide shopping information from the mobile terminal to the device broker after receiving the association instruction, the shopping information including registered commodity information regarding commodities registered for purchase via the mobile terminal.

10. The server apparatus according to claim 9, wherein
the processor is further configured to determine, based on the collected operating states, a settlement method available to a customer using the plurality of peripheral devices connected to the device broker and provide settlement method information to the mobile terminal before receiving the association instruction, the settlement method information indicating one or more settlement methods presently available to the customer using the plurality of peripheral devices connected to the device broker.

11. The server apparatus according to claim 9, wherein the storage unit stores a device ID for each of the plurality of peripheral devices connected to the device broker.

12. The server apparatus according to claim 11, wherein the device IDs for the plurality of peripheral devices are stored in association with an operating state of the corresponding peripheral device.

13. The server apparatus according to claim 12, wherein the device IDs for the plurality of peripheral devices are stored in association with the second identification information of the device broker.

14. The server apparatus according to claim 11, wherein the device IDs for the plurality of peripheral devices are stored in association with the second identification information of the device broker.

15. The server apparatus according to claim 9, wherein the shopping information is stored in the storage unit in association with the first identification information of the mobile terminal.

16. The server apparatus according to claim 15, wherein the mobile terminal registers commodities for purchase in the shopping information stored in the storage unit by sending a commodity code from a scanned barcode to the server apparatus.

17. A store checkout system, comprising:
a server apparatus;
a mobile terminal connected to the server apparatus via a network and configured to acquire a commodity code of an item registered in a sales transaction by scanning a code symbol on the item with the mobile terminal; and
a device broker including:
a device connection unit configured to allow a plurality of devices to be detachably connected thereto;
a communication interface configured to communicate with the server apparatus;
a processor configured to:
receive from the device connection unit an input of first identification information from a first device connected to the device connection unit, the first identification information identifying the mobile terminal connected to the network;
notify the server apparatus, via the network communication interface, of an association between the first identification information and second identification information of the device broker to cause the server apparatus to relay information between the mobile terminal and the device broker; and
execute accounting processing for the item registered in the sales transaction by the mobile terminal based on shopping information relayed from the server apparatus, the accounting processing using one or more devices connected to the device connection unit.

18. The store checkout system according to claim 17, wherein
the first device is a code reader, and
the first identification information is decoded from a code symbol displayed by the mobile terminal and read by the first device.

19. The store checkout system according to claim 17, wherein
the plurality of peripheral devices connected to the device connection unit includes a first group and a second group,
the first group being associated with second information of a first version and the second group being associated with second information of a second version distinguishable from the first version.

20. The store checkout system according to claim 17, wherein the server apparatus is configured to:
collect operating states of the peripheral devices connected to the device broker, and
determine, based on the collected operating states, a settlement method available to a customer using the plurality of peripheral devices connected to the device broker and provide settlement method information to the mobile terminal before receiving the association instruction, the settlement method information indicating one or more settlement methods presently available to the customer using the plurality of peripheral devices connected to the device broker.
